(19) United States
(12) Patent Application Publication
(10) Pub. No.: US 2013/0059460 A1
(43) Pub. Date: Mar. 7, 2013

(54) Miniature Receptacle Electrical Connector

(71) Applicant: Naotaka Sasame, Saitama (JP)

(72) Inventor: Naotaka Sasame, Saitama (JP)

(73) Assignee: FCI, Guyancourt (FR)

(21) Appl. No.: 13/640,538

(22) PCT Filed: Apr. 6, 2011
(86) PCT No.: PCT/IB2011/000938

§ 371 Date: Nov. 13, 2012

(30) Foreign Application Priority Data
Apr. 12, 2010 (IB) PCT/IB2010/001280

(51) Int. Cl. H01R 13/73; H01R 13/62

(52) U.S. Cl. 439/345; 439/660

(57) ABSTRACT

A receptacle connector includes a housing and first and second sets of conductive terminals attached to a respective first and second main surfaces of the housing. Each conductive terminal has a first end, a second end and a contact portion therebetween. The first end is offset from the contact portion along a direction perpendicular to the contact portion. The contact portion is attached to one of the first and second main surfaces by insert-molding. The first end extends through an end surface of the housing. The first ends are aligned in one row parallel to the first and second main surfaces such that the molding process is simplified. In a one type of example receptacle connector, the conductive terminals are strongly and precisely attached to the housing, hence the physical dimension can be ensured, and the mateability with counterpart plug connector as well as manufacturability can be improved.

### FIELD OF THE INVENTION

The present invention relates to an electrical connector, and particularly to a receptacle electrical connector of compact size.

### BACKGROUND OF THE INVENTION

Many electronic devices have been developed toward directions of high integration and compact in size. As necessary interface components, miniature electrical connectors are also proposed to meet these requirements. One typical example is the High Definition Multimedia Interface (HDMI) connector for use in audio visual systems to transmit high quality audio visual signals, such as televisions, DVD players and video cameras with HDMI capacity. A newly proposed micro HDMI connector for this purpose is about half the size of a standard HDMI connector.

While reduced physical size of electronic device brings the convenience of usage and portability with the same or even better performance, manufacturers of electrical connectors for these small devices are facing the challenges of production quality and manufacturability of the smaller and smaller connectors. In the micro HDMI connector, the elements such as the conductive terminals become so tiny and the pitch is so close that the conventional manufacturing technology used to produce standard sized HDMI connector become impractical.

It is therefore desirable to provide a receptacle connector which meets the miniaturization requirements and has an improved structural and manufacturability features.

### SUMMARY OF THE INVENTION

Embodiments of the present invention provide a miniature receptacle electrical connector which is compact in physical dimensions and meanwhile the structure is stronger to meet manufacturing process and quality requirements. In one aspect, a receptacle connector under the inventive concept of the present invention includes a housing onto which first and second sets of conductive terminals are attached to a respective first and second main surfaces of the housing. Each conductive terminal has a first end, a second end and a contact portion between the first and second ends. The first end is offset from the contact portion along a direction perpendicular to the contact portion.

The contact portion is attached to one of the first and second main surfaces by insert-molding, and with the first end extends through an end surface of the housing. The first ends are aligned in one row parallel to the first and second main surfaces such that the molding process is simplified. In a receptacle connector according to the present invention, the conductive terminals are strongly and precisely attached to the housing, hence the physical dimension can be ensured and the mateability with counterpart plug connector as well the manufacturability can be improved.

For a better understanding of the present invention and its purpose and preferred embodiments, further description accompanied by figures is provided in detail below.

### BRIEF DESCRIPTION OF THE DRAWINGS

FIG. 1 is a perspective view of a receptacle connector according to one embodiment of the present invention;

FIG. 2 is an exploded view of FIG. 1

FIG. 3 is an enlarged partial view of FIG. 2 viewing from a different angle;

FIG. 4 is an enlarged perspective view showing conductive terminals of the connector shown in FIG. 1;

FIGS. 5A and 5B are enlarged partial views of FIG. 4;

FIG. 6 is a perspective view showing first and second sets of conductive terminals of the connector shown in FIG. 1;

FIG. 7 is perspective view of FIG. 6 showing the first and second sets of conductive terminals being attached together;

FIG. 8 is a partial perspective view showing an upper mold part for fabricating the connector shown in FIG. 1;

FIG. 9 is a partial perspective view showing a lower mold part for fabricating the connector shown in FIG. 1;

FIG. 10 is a partial perspective view of showing the upper and lower mold parts of FIGS. 8 and 9 being placed together with the conductive terminals;

FIG. 11 is a cross sectional view of FIG. 10 when the upper and lower mold parts are closed;

FIG. 12 is a partial cross sectional view of FIG. 11 along A-A showing one of first set of conductive terminals;

FIG. 13 is a partial cross sectional view of FIG. 11 along B-B showing one of second set of conductive terminals;

FIG. 14 is a perspective view showing the housing and conductive terminals after the insert molding process;

FIG. 15 is a partial enlarged perspective top view of FIG. 14;

FIG. 16 is a partial enlarged perspective top view of FIG. 14 after the front carriers are removed;

FIG. 17 is a partial enlarged perspective bottom view of FIG. 16;

FIG. 18 is a partial enlarged front view of FIG. 17;

FIG. 19 is a partial cross sectional view of FIG. 18 along C-C;

FIG. 20 is a partial cross sectional view of FIG. 18 along D-D;

FIG. 21 is a partial cross sectional view of FIG. 18 along E-E;

FIG. 22 is a front view of FIG. 1;

FIG. 23 is a partial enlarged view of FIG. 22;

FIG. 24 is a perspective rear view of FIG. 1.

### DETAILED DESCRIPTION OF PREFERRED EMBODIMENTS

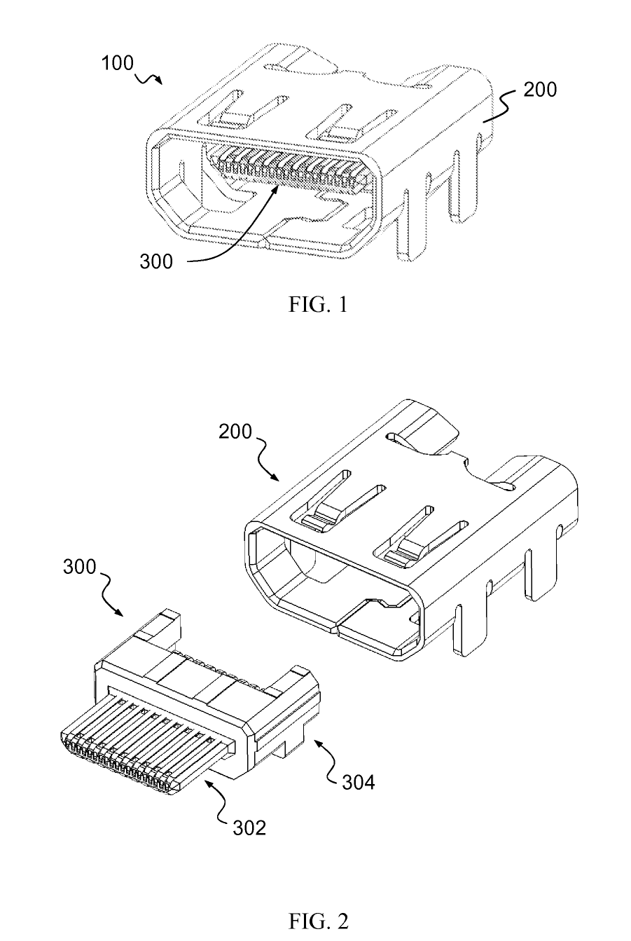

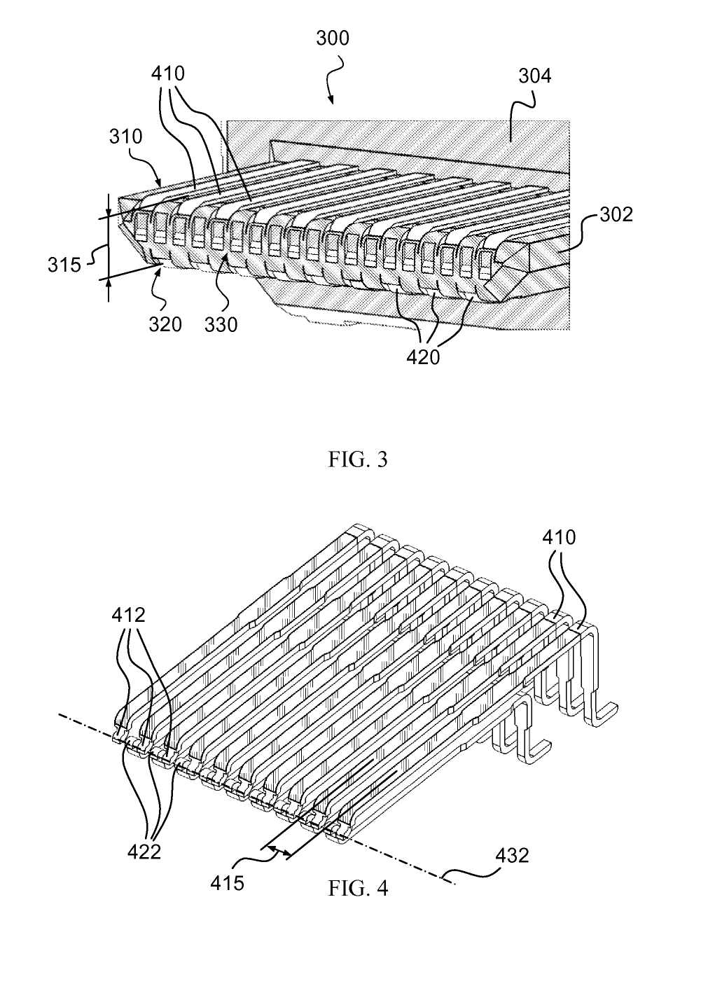

As shown in FIGS. 1, 2 and 3, a receptacle connector 100 includes a shell 200, a housing 300 disposed in shell 200 and first and second sets of conductive terminals 410, 420 disposed in housing 300.

Housing 300 includes a base portion 304 and a tongue 302 projected from base portion 304. Tongue 302 has a first main surface 310, a second main surface 320 opposite to first main surface 310, and a front end surface 330 joining first and second main surfaces 310, 320. First and second main surfaces 310 and 320 are parallel to each other, defining a distance 315 therebetween which is the thickness of tongue 302.

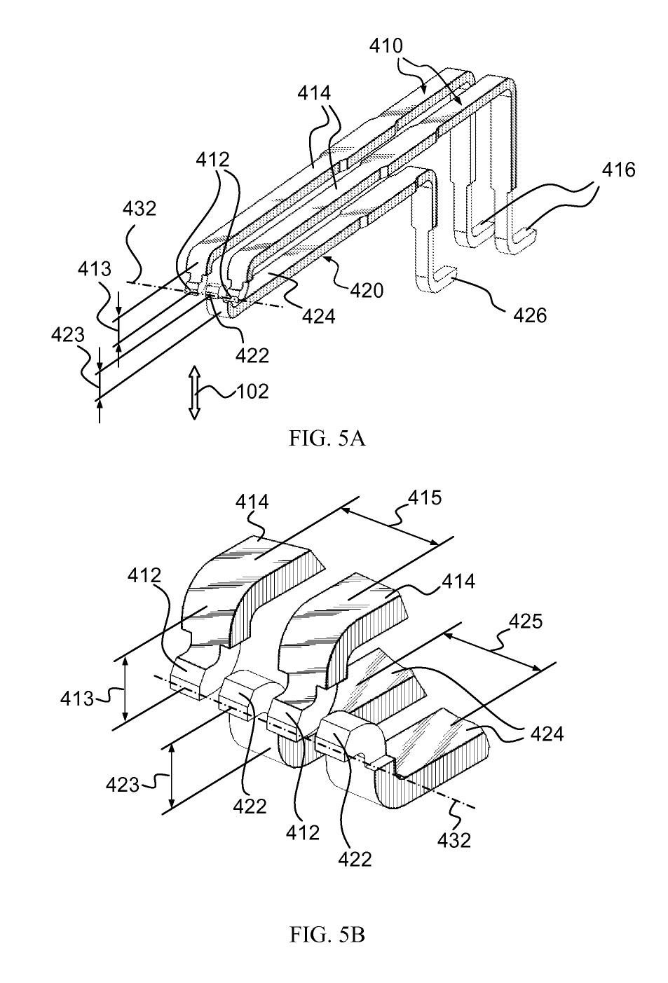

As shown in FIGS. 4, 5A and 5B, each of first set of conductive terminals 410 has a first end 412, a second end 416 and a contact portion 414 between first and second ends 412 and 416. First end 412 is offset downward from contact portion 414 with a first offset distance 413, along a vertical direction 102 which is perpendicular to contact portion 414. Contact portions 414 of first set of conductive terminals 410 are attached to first main surface 310 of tongue 302, and with front ends 412 protruding from end surface 330. Contact portions 414 are parallel to and spaced apart from each other, with a first pitch 415 between adjacent contact portions 414.

Likewise, each of second set of conductive terminals 420 has a first end 422, a second end 426 and a contact portion 424 between first and second ends 422 and 426. First end 422 is offset upward from contact portion 424 with a second offset distance 423, along vertical direction 102. Contact portions 424 of second set of conductive terminals 420 are attached to second main surface 320 of tongue 302, and with front ends 422 protruding from end surface 330. Contact portions 424 are parallel to and spaced apart from each other, with a second pitch 425 between adjacent contact portions 424.

In the present embodiment, first pitch 415 and second pitch 425 are the same, first offset distance 413 and second offset distance also have the same value. In addition, first set of conductive terminals 410 and second set of conductive terminals 420 are positioned in a staggered manner, i.e. first end 422 of each of the second set of conductive terminals 420 is positioned in the space between the first ends 412 of two adjacent ones of the first set of conductive terminals 410.

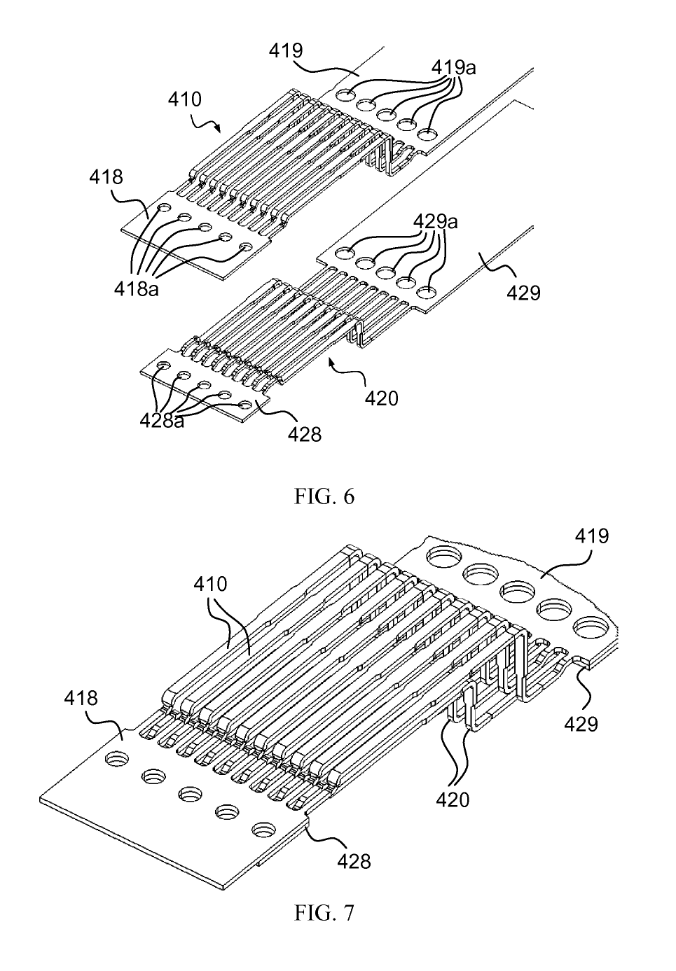

First and second sets of conductive terminals 410 and 420 are formed by stamping metal sheets, each integrally connected to respective front and rear carriers 418, 419 and 428, 429 as shown in FIG. 6. The stamp-formed integral piece of conductive terminals 410 and 420 are then grouped together, with positioning holes 418a, 428a and 419a, 429a aligned to each other, as shown in FIG. 7. The grouped conductive terminals 410 and 420 are now ready to undergo an insert-molding process as illustrated below.

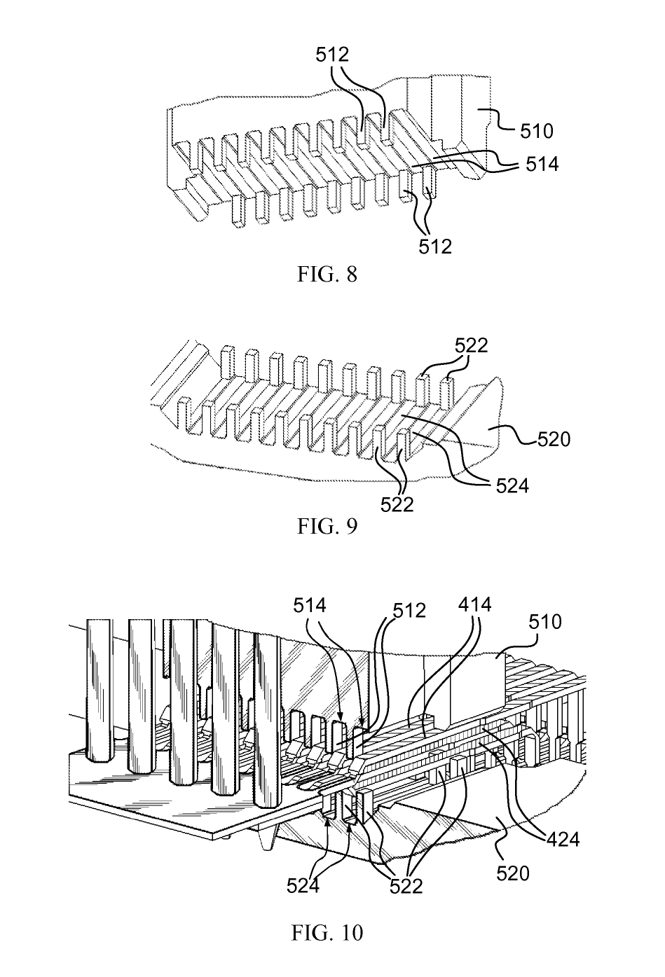

FIG. 8 shows an upper mold part 510. FIG. 9 shows a lower mold part 520. Upper mold part 510 has a plurality of upper mold grooves 514, and a plurality of downward-projecting posts 512 between upper grooves 514. Similarly, lower mold part 520 has a plurality of lower mold grooves 524, and a plurality of upward-projecting posts 524 between lower mold grooves 524.

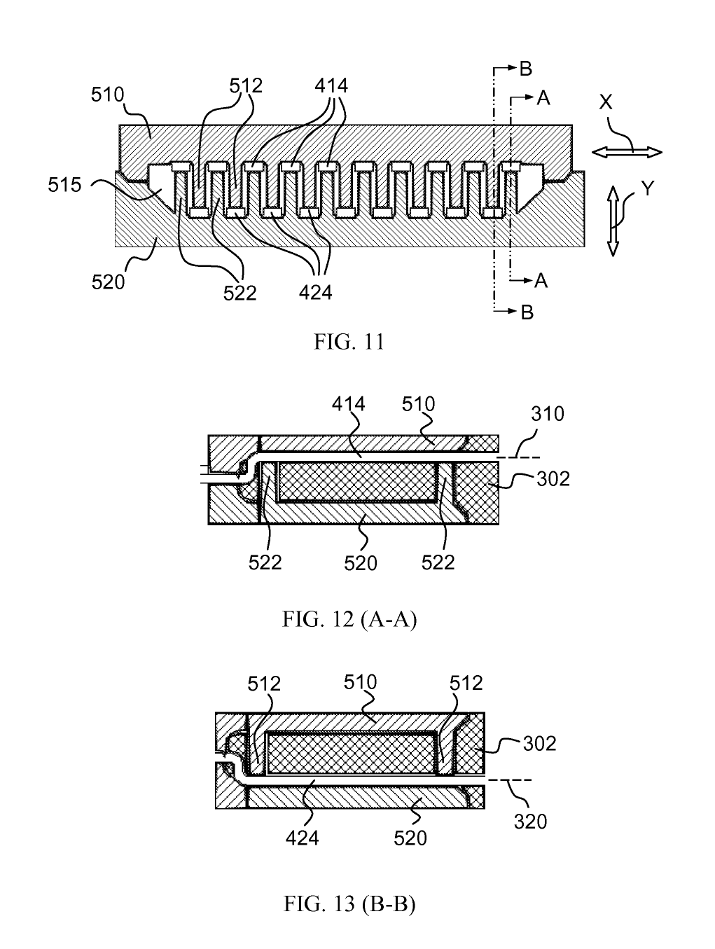

As shown in FIG. 10, grouped conductive terminals 410 and 420 are placed between upper and lower mold parts 510 and 520, with contact portions 424 of second set of conductive terminals 420 placed in lower mold grooves 524. When upper mold part 510 and lower mold part 520 are closed together, there is formed a mold cavity 515, and contact portions 414 of first set of conductive terminals 410 are received in upper grooves 514, as shown in FIG. 11. In the meantime, downward-projecting posts 512 of upper mold part 510 are brought into contact with contact portions 424 of second sets of conductive terminals 420, and upward-projecting posts 522 of lower mold part 520 are brought into contact with contact portions 414 of first set of conductive terminals 410. Positioning contact portions 414 and 424 between upper and lower mold parts 510 and 520 in the above manner, contact portions 414 and 424 are hold by respective upper and lower mold grooves 514, 524 as well as posts 512, 522, such that relative movement between contact portions 414 and 424, along X direction (FIG. 11) is prevented, hence the pitch between the contact portions 414 and 424 is fixed. In addition, posts 512 and 522 abut contact portions 424 and 414 against lower and upper mold parts 520 and 510, respectively, hence contact portions 414 and 424 are prevented from moving toward each other along Y direction. In this regard, shifting, warping or bowing of contact portions 414 and 424 during the molding process is prevented. Molten material for forming the housing, e.g. plastic, can then be injected into molding cavity 515 to form housing 300. Contact portions 414 and 424 are partially embedded to tongue 302 accordingly, at respective first main surface 310 and second main surface 320, as shown in FIGS. 12 and 13.

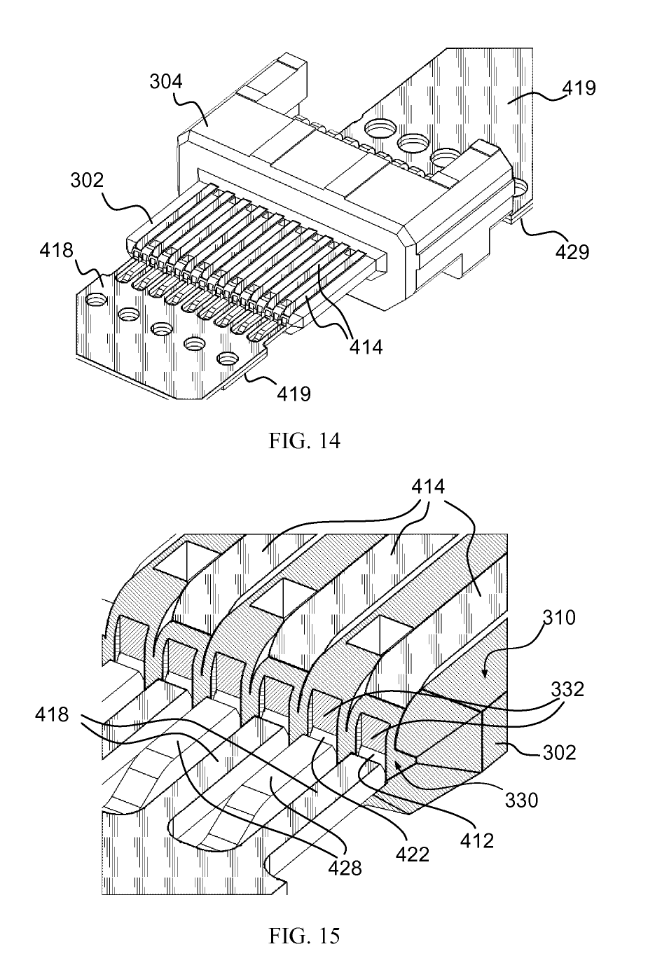

Upon completion of the insert-molding process and after the mold parts are removed, as shown in FIGS. 14, and 15, housing 300 is formed which includes base portion 304 and tongue 302 projecting from base portion 304 toward front side. Contact portions 414 and 424 of first and second sets of conductive terminals 410 and 420 (only first set of contact portions 414 are shown in FIGS. 14 and 15) are fixed to tongue 302, and exposed at respective first and second main surfaces 310, 410 for making electrical connection with a counterpart plug connector (not shown).

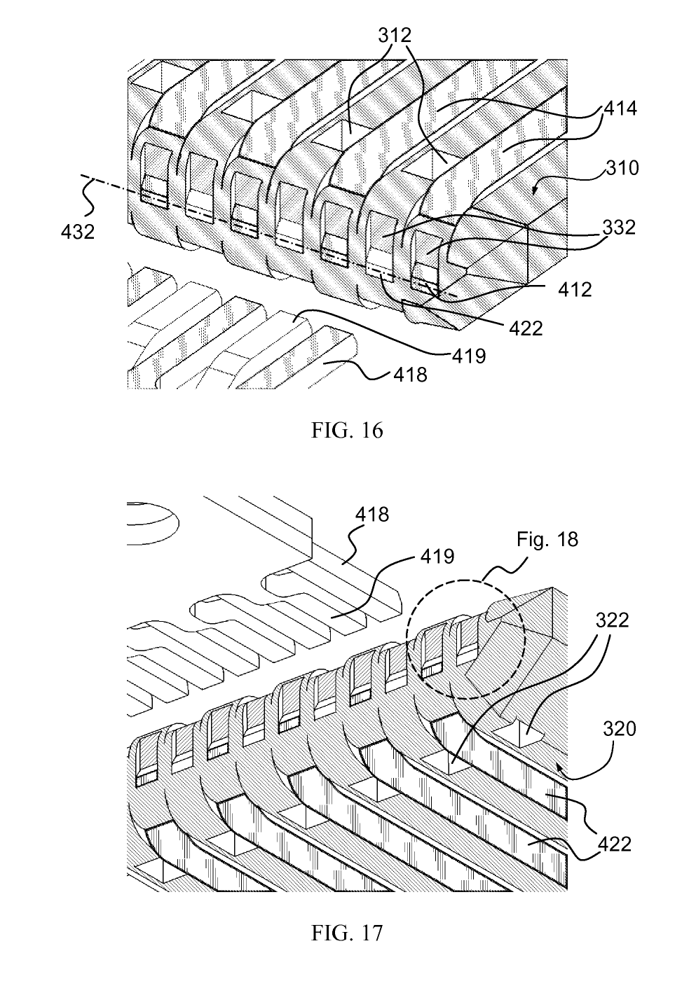

Recesses 332 may be formed at front end surface 330 of tongue 302. Each recess is positioned adjacent to first ends 412, 422 of first and second set of conductive terminals 410, 420. Recess 332 provides additional spaces for removal of front carriers 418 and 428 when these carriers are bent toward front end surface 330. After front carriers 418 and 428 are removed, as shown in FIGS. 16 and 17, assembly of conductive terminals 410 and 420 to housing 300 is completed. Front ends 412 and 422 of first and second sets of conductive terminals 410, 420 are aligned in one row 432, indicating the same alignment status of first and second sets of conductive terminals 410, 420 before the inject-molding process.

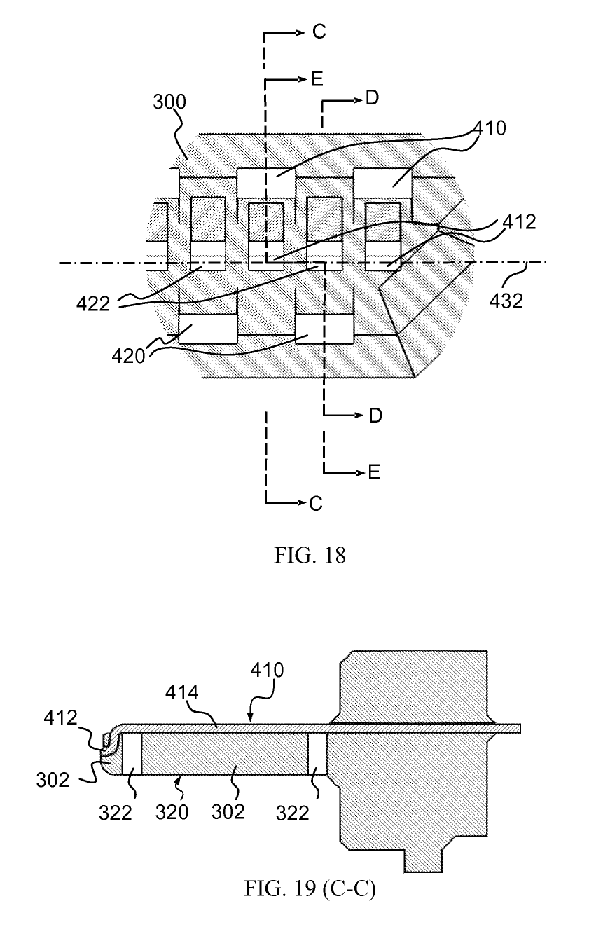

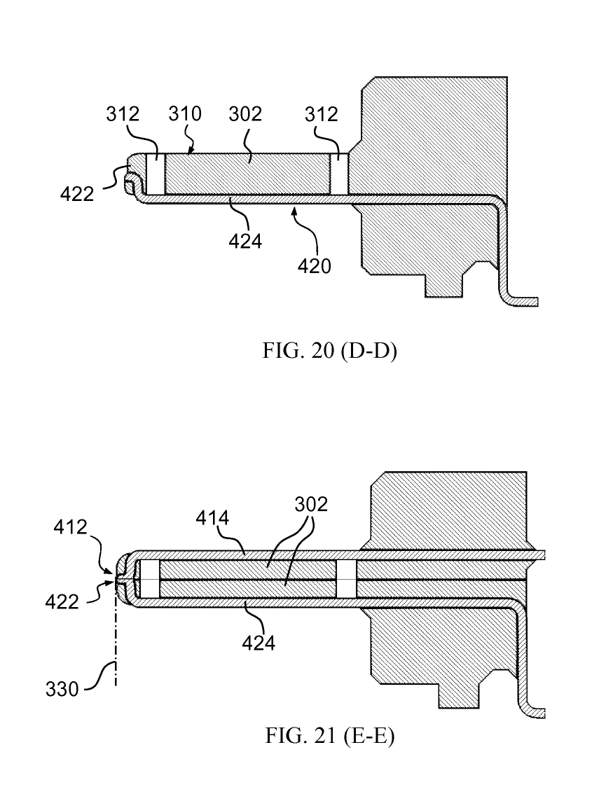

At first main surface 310 of tongue 302, as shown in FIGS. 16 to 20, there are formed first set of cavities 312 between first contact portions 414. Cavities 312 are formed after upper mold part 510 (FIG. 13) is removed. Corresponding to the shape of and position of downward-projecting posts 512 of upper mold part 510, cavities 312 extend from first main surface 310 to second contact portion 424 of second set of conductive terminals 420. Likewise, at second main surface 320 of tongue 302, as shown in FIG. 17, there are formed second set of cavities 322 between second contact portions 424. Cavities 322 are formed after lower mold part 520 (FIG. 12) is removed. Corresponding to the shape of and position of upward-projecting posts 522 of lower mold part 520, cavities 322 extend from second main surface 320 to first contact portion 414 of first set of conductive terminals 410.

Cavities 312 and 322 indicate the usage of downward-projecting posts 512 and upward-projecting posts 522 of respective molding parts during the injection-molding process. In addition, through cavities 312 and 322 it is also possible to conduct inspection and verification of the presence and correct positions of contact portions 414 and 424.

After first and second sets of conductive terminals 410 and 420 are fixed to housing 300 by insert molding process and with carriers removed as illustrated above, shell 200 may be assembled to housing 300 to form the final connector 100.

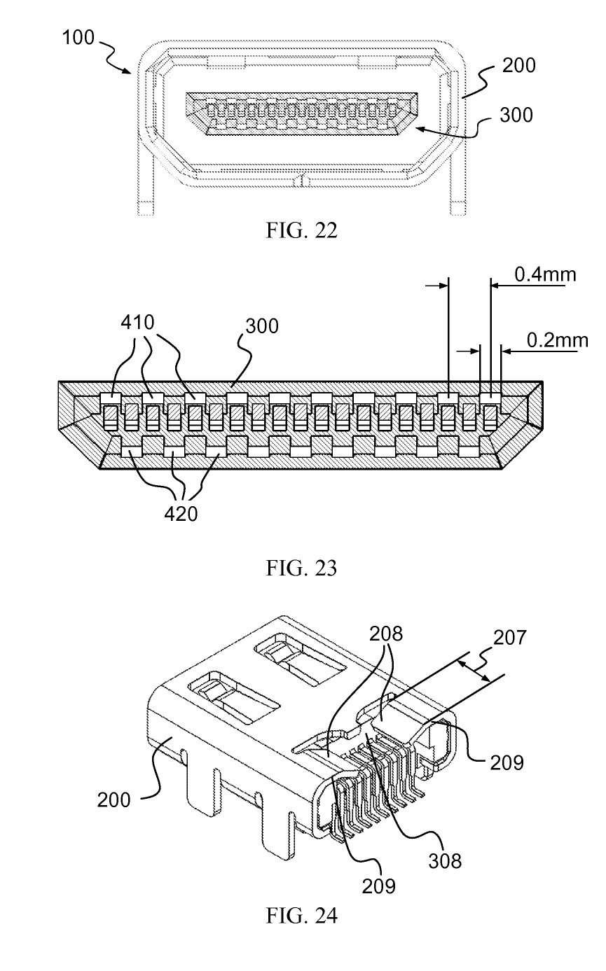

Solutions provided by the present invention are applicable to fabricate miniature receptacle electrical connectors in which the components such as conductive terminals have relatively small physical dimensions. In one example, a receptacle connector is configured to comply with High Definition Multimedia Interface (HDMI), Type D standard, i.e. having a 0.2 mm width conductive terminals and 0.4 mm pitch, as shown in FIGS. 21 and 22. This type of HDMI Type D connector may be fabricated by adopting the structure and process illustrated above. Conductive terminals 410 and 420 may be reliably attached and fixed to the connector housing. When mating with a counterpart plug connector (not shown), the attachment of conductive terminals 410, 420 to housing 300 is sufficiently strong to provide desired mating cycles. In addition, it is also possible that a HDMI connector according to embodiment of the present invention can withstand a higher mating force exerted by the counterpart plug connector and frictional force applied to the contact portions of conductive terminals. In this regard, in one embodiment according to the present invention as shown in FIG. 24, shell 200 has a pair of wings 208 at the rear end. Wings 208 are bent inward to abut rear surface 308 of housing 300. Rear end edge 209 of shell 200 forms one side edge of each wing 208, hence the width 207 of wing 208 can be maximized and the abutment strength against the backward movement tendency of housing 300 is increased.

Although embodiments of the present invention have been illustrated in conjunction with the accompanying drawings and described in the foregoing detailed description, it should be appreciated that the invention is not limited to the embodiments disclosed. Therefore, the present invention should be understood to be capable of numerous rearrangements, modifications, alternatives and substitutions without departing from the spirit of the invention as set forth and recited by the following claims.

1. A receptacle connector, comprising:
a housing having a first main surface, a second main surface opposite to the first main surface and an end surface joining the first and second surfaces;
first and second sets of conductive terminals disposed in the housing, each conductive terminal having a first end, a second end and a contact portion between the first and second ends, the first end being offset from the contact portion;
the contact portions of the first set of the conductive terminals being attached to the first main surface of the housing, the first ends of the first set of conductive terminals are positioned through the end surface of the housing;
the contact portions of the second set of the conductive terminals being attached to the second surface of the housing, the first ends of the second set of conductive terminals are positioned through the end surface of the housing.

2. The receptacle connector of claim 1, wherein the first ends of the first and second sets of conductive terminals are aligned in one row.

3. The receptacle connector of claim 1, wherein the first ends of the first and second sets of conductive terminals are arranged in a staggered manner.

4. The receptacle connector of claim 1, wherein the end surface of the housing having recesses each positioned adjacent to the first end of one of the first and second set of conductive terminals.

5. The receptacle connector of claim 1, wherein the first set of conductive terminals are disposed spaced apart from each other, wherein the housing further comprises a plurality of cavities each located within a gap between adjacent two of the first set of conductive terminals.

6. The receptacle connector of claim 5, wherein each of the cavities extend between one of the first and second main surfaces of the housing and the contact portion of the other one of the first and second sets of conductive terminals.

7. The receptacle connector of claim 1, further comprising a shell within which the housing is disposed, wherein the shell comprising a pair of wings bent inwardly at a rear end thereof, wherein the pair of wings abuts the housing to prevent backward movement of the housing relative to the shell.

8. The receptacle connector of claim 7, wherein a rear edge of the shell forms one edge of the pair of wings.
